(19) United States
(12) Patent Application Publication
(10) Pub. No.: US 2012/0215597 A1
(43) Pub. Date: Aug. 23, 2012

(54) SYSTEM FOR ANALYZING SOCIAL MEDIA BEHAVIORAL INFLUENCE

(75) Inventor: Erik Stephen Ross, Charlotte, NC (US)

(73) Assignee: BANK OF AMERICA CORPORATION, Charlotte, NC (US)

(21) Appl. No.: 13/029,642

(22) Filed: Feb. 17, 2011

(51) Int. Cl. G06Q 30/00

(52) U.S. Cl. 705/14.1

(57) ABSTRACT

Embodiments of the invention are directed to monitoring selected activity of a user of one or more social networks and providing offers to the user based on such selected activities. For example, selected activities could be the number of other users of the social network that are associated with the user, the number of posts entered by the user on the social network, the number of other users that respond to a post by the user, a type of product, service, or event that the user either selects or enters a posting for, and/or associations the user has with other selected users of the social network. In some embodiments, financial data associated with the user and other users of the social network may be analyzed to determine the user's influence on other users of the social network and provide offers to the user based on such influence.

### BACKGROUND

The Internet provides channels for reaching customers and providing information, advertising, and offers related to products, services, events, etc. However, sales and marketing campaigns are often not as effective as they might be, because they provide the wrong information, advertisements, or offers to the customer, or alternatively, provide the right information, advertisements, or offers at the wrong time. The Internet, likewise, provides customers with the ability to quickly locate information about products in which they are interested, and to purchase those products without leaving their computer. However, online customers often cannot find the exact product or service that they want, they fail to find what they want at a price that they find attractive, they find what they want but the product is out of stock or the service is no longer available, or they fail to utilize discounts that are available for the products or services. These scenarios result in customers not making their intended purchases, discounts or promotions offered by the merchant not being utilized, and customers not receiving the benefit of such discounts or promotions.

Marketing to specific individuals within a social network is somewhat limited in scope and is impractical in most cases. Most merchants want to market to the broadest set of possible consumers. Other than when the possible consumer reaches out and follows the merchant via the social network, however, specific marketing to individuals is limited. This specific marketing could provide to be cost effective and more focused to the specific target markets in which the commercial entity wants to target.

### SUMMARY OF SELECTED EMBODIMENTS OF THE PRESENT INVENTION

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

In some embodiments, a method is provided. In one embodiment, the method comprises receiving data from one or more social media networks associated with a user and determining a selected activity of the user associated with the one or more social media networks based on the data using a processor. Based at least in part on the selected activity of the user, an offer is sent to the user. Depending on the embodiment, the selected activity may be one or more of the following:
1. the number of affiliated users with a social network that are associated with the user;
2. the number of times the user enters postings on the one or more social networks;
3. the number of times that affiliated users to a social network respond to one or more posts entered by the user on the social network;
4. a type of product, service, or event that the user enters one or more postings on the one or more social networks;
5. a number or type of product, service or event that the user has selected on the one or more social networks; and/or
6. one or more selected users affiliated with one or more social networks that are associated with the user.

In some embodiments, the method may further comprise analyzing financial transaction data associated with the user. In this embodiment, sending an offer to the user may comprise sending an offer to the user based at least in part on the selected activity of the user and the financial data associated with the user.

In some embodiments the method may comprise analyzing financial transaction data associated with the user and associated with other users affiliated with a social network that are also associated with the user. From this analysis, the method determines whether a selected activity of the user influences the other users to perform the same activity and sends an offer to the user based on determining that the user influences other users. In some embodiments, the influence of the user is determined by analyzing whether other users purchase a product or service or select an event after the user has purchased the product or service or selected the event.

As an alternative, the method may determine that the user is influenced by selected other users of the social network by analyzing financial data of the user and that of other users of the social network and based on such a determination provide an offer to the user.

In some embodiments, analysis of other users of a social network associated with the user and financial data associated with such users may be used to determine parameters of an offer made to the user. For example, the method may analyze financial transaction data associated with the user and associated with other users affiliated with a social network that are also associated with the user. The method may determine based at least in part on the financial data whether one or more of the other users engage in a selected financial behavior and send an offer regarding a credit decision to the user based at least in part on the user's association with other users in the social network that engage in the selected financial behavior.

In some embodiments, the method may further compare financial transaction data associated with other users with the financial transaction data associated with the user and determine that at least one of the other users exerts an influence on a financial behavior of the user. Based on this determination, the method may modify the credit offer based at least in part on the extent of the influence.

In some embodiments, the invention is provided as an apparatus. In one embodiment, the apparatus comprises a processing element configured to receive data from one or more social media networks associated with a user and determine a selected activity of the user associated with the one or more social media networks based on the data. Based at least in part on the selected activity of the user, an offer is sent to the user by the processing element. Depending on the embodiment, the selected activity may be one or more of the following:
1. the number of affiliated users with a social network that are associated with the user;
2. the number of times the user enters postings on the one or more social networks;
3. the number of times that affiliated users to a social network respond to one or more posts entered by the user on the social network;
4. a type of product, service, or event that the user enters one or more postings on the one or more social networks;
5. a number or type of product, service or event that the user has selected on the one or more social networks; and/or
6. one or more selected users affiliated with one or more social networks that are associated with the user.

In some embodiments, the processing element may further be configured to analyze financial transaction data associated with the user. In this embodiment, the processing element may comprise send an offer to the user based at least in part on the selected activity of the user and the financial data associated with the user.

In some embodiments the processing element may be configured to analyze financial transaction data associated with the user and associated with other users affiliated with a social network that are also associated with the user. From this analysis, the processing element may be configured to determine whether a selected activity of the user influences the other users to perform the same activity and send an offer to the user based on determining that the user influences other users. In some embodiments, the influence of the user is determined by analyzing whether other users purchase a product or service or select an event after the user has purchased the product or service or selected the event.

As an alternative, the processing element may be configured to determine that the user is influenced by selected other users of the social network by analyzing financial data of the user and that of other users of the social network and based on such a determination provide an offer to the user.

In some embodiments, analysis of other users of a social network associated with the user and financial data associated with such users may be used to determine parameters of an offer made to the user. For example, the processing element may be configured to analyze financial transaction data associated with the user and associated with other users affiliated with a social network that are also associated with the user. The processing element may be configured to determine based at least in part on the financial data whether one or more of the other users engage in a selected financial behavior and send an offer regarding a credit decision to the user based at least in part on the user's association with other users in the social network that engage in the selected financial behavior.

In some embodiments, the processing element may be configured to further compare financial transaction data associated with other users with the financial transaction data associated with the user and determine that at least one of the other users exerts an influence on a financial behavior of the user. Based on this determination, the credit offer may be modified based at least in part on the extent of the influence.

In some embodiments, the various operations of the method may be performed using a computer program product comprising a non-transitory computer-readable medium, wherein the non-transitory computer-readable medium comprises computer-executable program code stored therein. The computer-executable program code portions comprise a first program code portion configured to receive data from one or more social media networks associated with a user and a second program code portion configured to determine a selected activity of the user associated with the one or more social media networks based on the data. A third program code portion is provided to send an offer to the user based at least in part on the selected activity of the user. Depending on the embodiment, the selected activity may be one or more of the following:
1. the number of affiliated users with a social network that are associated with the user;
2. the number of times the user enters postings on the one or more social networks;
3. the number of times that affiliated users to a social network respond to one or more posts entered by the user on the social network;
4. a type of product, service, or event that the user enters one or more postings on the one or more social networks;
5. a number or type of product, service or event that the user has selected on the one or more social networks; and/or
6. one or more selected users affiliated with one or more social networks that are associated with the user.

In some embodiments, the computer program product may further comprise fourth program code portion configured to analyze financial transaction data associated with the user. In this embodiment, the third program code portion is configured to send an offer to the user based at least in part on the selected activity of the user and the financial data associated with the user.

In another embodiment, the computer program product may further comprise fourth program code portion configured to analyze financial transaction data associated with the user and associated with other users affiliated with a social network that are also associated with the user. A fifth program code portion is provided and configured to determine based at least in part on the financial data whether a selected activity of the user influences the other users to perform the same activity. In this embodiment, the third program code portion is configured to send an offer to the user based on determining that the user influences other users. In a further embodiment, the fifth program code portion is configured to determine that other users purchase a product or service or select an event after user has purchased the product or service or selected the event.

In other embodiments, the computer program product may further comprise fourth program code portion configured to analyze financial transaction data associated with the user and associated with other users affiliated with a social network that are also associated with the user and fifth program code portion configured to determine based at least in part on the financial data whether a selected activity of one or more of the other users influences the user to perform the same activity. In this embodiment, the third program code portion is configured to send an offer to the user based on determining that the user is influenced by one or more of the other users.

In another embodiment, the computer program product may further comprise fourth program code portion configured to analyze financial transaction data associated with the user and associated with other users affiliated with a social network that are also associated with the user and fifth program code portion configured to determine based at least in part on the financial data whether one or more of the other users engage in a selected financial behavior. In this embodiment, the third program code portion is configured to send an offer regarding a credit decision to the user based at least in part on the user's association with other users in the social network that engage in the selected financial behavior.

In some embodiment, the computer program product further comprises sixth program code portion configured to compare financial transaction data associated with other users with the financial transaction data associated with the user. Seventh program code portion is provided and configured to determine that at least one of the other users exerts an influence on a financial behavior of the user. Further, an eighth program code portion is provided and configured to modify the credit decision based at least in part on the extent of the influence.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described some embodiments of the present invention in general terms, reference will now be made to the accompanying drawings, wherein:

FIG. 1A is a flow diagram illustrating a general process flow of an apparatus for analyzing social media behavioral influence, in accordance with an embodiment of the present invention;

FIG. 1B is a flow diagram illustrating a general process flow of an apparatus for analyzing social media behavioral influence, in accordance with an embodiment of the present invention;

FIG. 1C is a flow diagram illustrating a general process flow of an apparatus for analyzing social media behavioral influence, in accordance with an embodiment of the present invention;

FIG. 2A is a flow diagram illustrating a general process flow of an apparatus for analyzing social media behavioral influence, in accordance with an embodiment of the present invention;

FIG. 2B is a flow diagram illustrating a general process flow of an apparatus for analyzing social media behavioral influence, in accordance with an embodiment of the present invention;

FIG. 3 is a block diagram illustrating a system for analyzing social media behavioral influence, in accordance with an embodiment of the present invention;

FIG. 4 is a block diagram illustrating technical components of a system for analyzing social media behavioral influence, in accordance with an embodiment of the present invention;

FIG. 5 is a mixed block and flow diagram of a system for analyzing social media behavioral influence, in accordance with an embodiment of the present invention;

FIG. 6 is a mixed block and flow diagram of a system for analyzing social media behavioral influence, in accordance with an embodiment of the present invention; and

FIG. 7 is an exemplary graphical user interface illustrating a social media network account, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the present invention are shown. Indeed, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, and/or operational aspects of any of the embodiments described and/or contemplated herein may be included in any other embodiment of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of apparatuses and/or methods. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory and/or non-transitory computer-readable medium (e.g., a memory, etc.) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

Further, although many of the embodiments of the present invention described herein are generally described as involving a “financial institution,” other embodiments of the present invention may involve one or more persons, organizations, businesses, and/or other entities that take the place of, and/or work in conjunction with, the financial institution to implement one or more portions of one or more of the embodiments described and/or contemplated herein.

In general terms, embodiments of the present invention relate to methods, apparatuses, and computer program products configured to analyze social network behavior of a user and provide offers to the user based on such behavior. For example, in some embodiments, the present invention may analyze data associated with a user relating to the user's activities on one or more social networks. The methods, apparatuses, and/or computer program products of the present invention may identify instances where the user appears to influence the activities, buying decisions, etc. of other users in the social network and based on this determination provide offers to the user, such as discounts, freebees, tickets, incentives, etc. to the user regarding products, services, events, etc. with the hopes that the user's involvement with the product, service, event, etc. will influence involvement by other users.

In other embodiments, the user's association with other users in the social network may be used to tailor an offer to the user based on influence by other users in the social network on the selected user. For example, it could be determined that the user is influenced by other users in either a positive or negative way. For example, some of the other users may participate in high risk business dealings or have questionable credit histories. Based on the amount of influence that these users may have on the selected user, credit offerings to the selected user may be adjusted to accommodate for this added risk.

It will be understood that the phrase “social media network” as used herein refers to social media systems, repositories, or networks. For example, in some embodiments, the social media network includes social media website, blogs, email lists, photo sharing websites, search engines, file sharing websites, and the like. Specific examples of social media networks include general social media open to the public such as Friendster^{SM}, hi5, Facebook, Bebo, MySpace, Linkedin®, Tagged™, Cyworld, Orkut, and Twitter; blogging networks such as Blogster™, Windows® Live Space™, and LiveJournal™; and special interest social media such as Multiply, Classmates.com®, Flixster, and Habbo®. Other examples of the social media networks include gaming site and/or games such as Farmville by Zynga®. It will be understood that the social media network include social media services that are open to the general public, services that are at least partially free, services that incur a fee, services that are at least partially private (e.g., invitation only social media networks), and the like.

As will be described in detail below, the present invention relates to evaluating either one or both data associated with the user from social networks and/or financial data associated with the user to determine proper offerings to make to the user. For example, it may be of interest to determine what users are considered influential on other users in a social network setting. Based on this determination, product, service, event, etc. offers may be provided to such influential users in an attempt to influence others to purchase the product, service, attend the event, etc. A determination of user's influence may be as simple as determining the number of the other users of one or more social network that are associated with the user. The activity of a user on a social network, such as the number of posts made by the user may be another indicator. The number of users and/or the frequency with which other users corresponds with the user via the social network, such as by responding to posts made by the user, sending emails to the user, etc. may also indicate the user's influence on others. Analyzing specific posts made by users regarding specific products, services, events, etc. and responses thereto may also indicate influence by the user regarding specific products, services, events, etc. Further, a determination of a user's influence may include other activities such as online television programs, advertisements, and movies that a user views, as well as online games that a user plays on a gaming device such as Sony PlayStation® devices, Xbox devices available from Microsoft Corporation, or Nintendo's Wii™ devices.

In addition to reviewing data about the user from social networks, financial data about the user and other users of the social network that have an associated with the user of interest may provide further information about either the influence the selected user has on other or the amount of influence others may have on the user. For example, an analysis of a group of users' transaction data over time can show a selected user going to the selected user's favorite restaurants with different groups of people. This user may then be identified as an influencer at least with regard to restaurants and a restaurant may want to give the user a coupon, since the user is likely to bring other people with him/her to the restaurant. In another example, a selected user may have a large number of associated users on a social network site where analysis of the data associated with the selected user and the users associated with the selected user indicates a trend where others make purchases of a product soon after the selected purchases the product. This may indicate that the selected user influences the purchases of other users, thereby indicating that providing discounts, coupons, incentives, etc. to the selected user may drive sales to other users.

Analysis of data from social networks and user financial data may also identify the financial influence of other users on the selected user in a social network that may modify offerings to the user, such as credit offerings to a user. For example, the social network and financial data for a user and other users associated with the selected user could be analyzed. Users that appear to make either financially sound or risky financial decisions based on their associated financial data can be identified. Then using the social networking data, influence of such users on the selected user may be assessed. Based on the amount of influence on the selected user, products offered to the user, such as loans, loan rates, financial products, etc. can be determined.

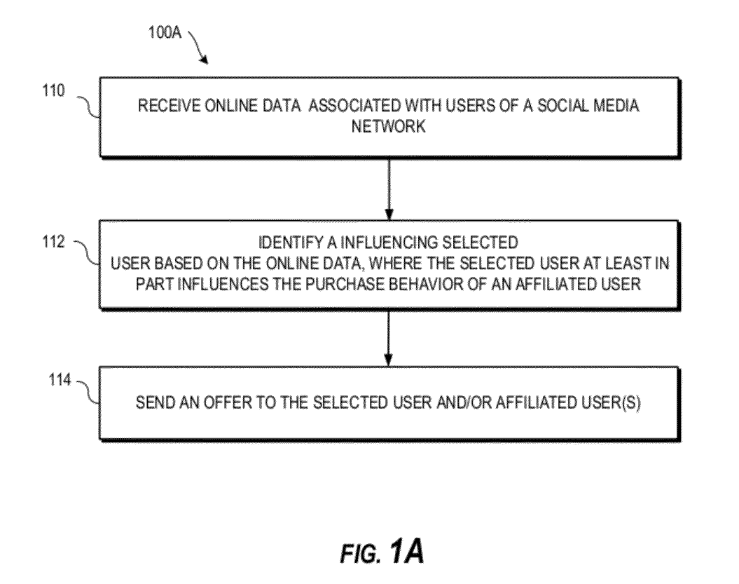

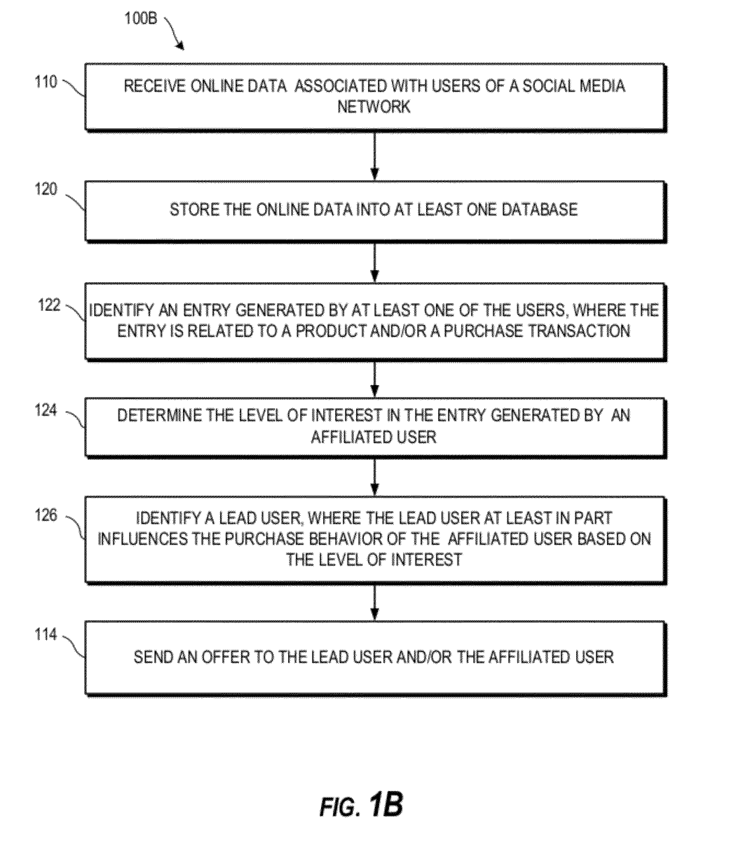

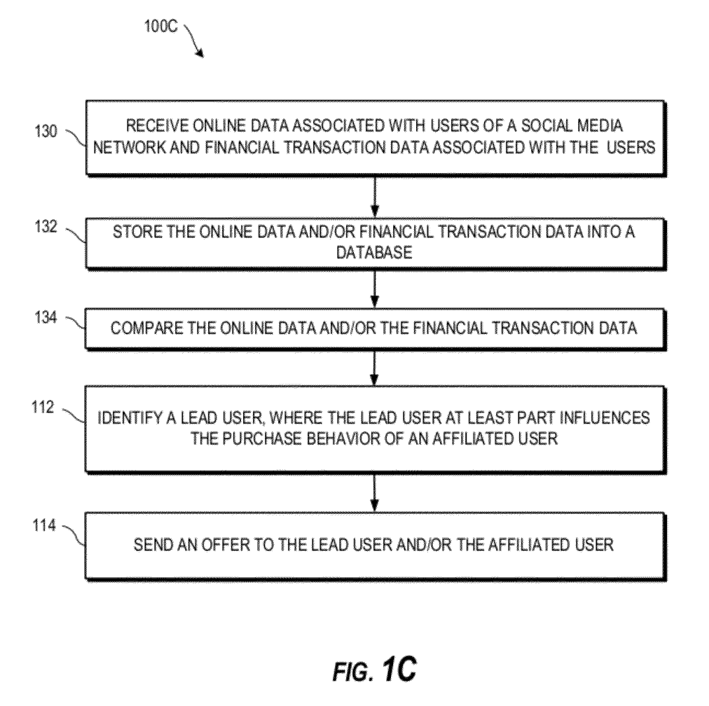

In FIG. 1, a general process flow 100A of an apparatus for analyzing social media behavioral influences is provided, in accordance with an embodiment of an invention. As provided by block 110, the apparatus is configured to receive online data associated with users of a social media network. As represented by the block 112, the apparatus is configured to identify a selected/lead user based on the online data, where the selected/lead user at least in part influences the purchase behavior an affiliated user. And as represented by the block 114, the apparatus is further configured to send an offer, reward, incentive, coupon, etc. to the user and or the affiliated user.

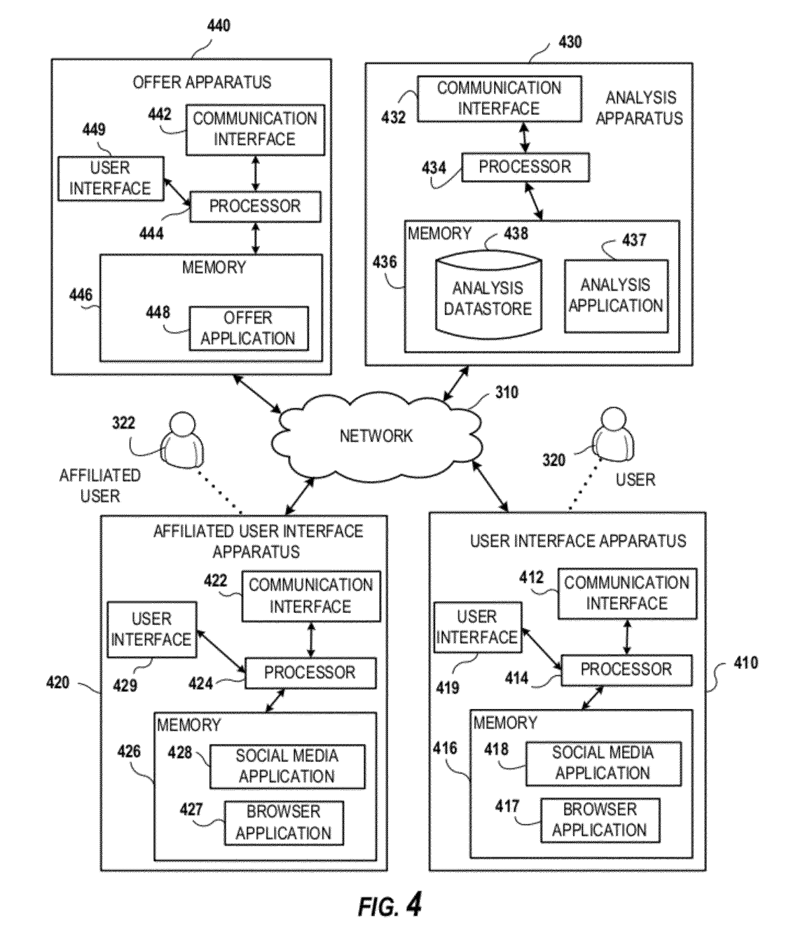

It will be understood that the apparatus having the process flow 100A can include one or more separate apparatuses. (e.g., the analysis apparatus 430, the offer apparatus 440, the affiliate user apparatus 420, the user apparatus 410 described in FIG. 4, and/or a trusted third party device, etc.).

It will be further understood that the user of social media network as used herein includes: one or more members of a social media network, or one or more non-members of a social media network that view, participate, or are otherwise associated with a social media network; and also, devices or network nodes associated with the one or more member or non-members of a social media network. It will be still further understood that the affiliated user as used herein include one or more members or non-members of a social media network that view, participate, or are otherwise associated with a social media network and that are associated with the user, including devices or network nodes associated with affiliated users. Examples of affiliated users include direct friends or online contacts of the user, indirect friends of the user (e.g., an online friend of a friend, etc.), anyone capable of viewing an entry generated by the user (e.g., a blog or forum reader), a creator or administrator of the social media network, co-members of groups or networks, etc. It will be further understood that user and affiliated user includes a single person, a group of people, a business entity, representatives of a business, an organization, and the like.

Regarding the block 110, it will be understood that the apparatus can be configured to receive the online data in any way. It will be understood the online data includes interactive communication, entries such as postings, comments, messages, responses, ratings, likes or dislikes, applications, groups, games, invitations, pictures, videos, files, links, digital receipts, unique product identifiers (e.g., singletons), usage data generated by sensors associated with products, and the like. The digital receipts further include data associated with the receipts such as quantities, stock keeping units (SKU's), product codes, product descriptions, ship-to postal codes, freight charge amount, duty amounts, and the like. It will be further understood that the online data includes data extending over a period of time (e.g., the entire lifetime of an online account, a year, a month, etc.). For example, in some embodiments, unauthenticated data such as search results are downloaded from one or more social media networks. The data is considered unauthenticated because it was not sent to a user-specific account. In other embodiments, for example, authenticated data, such as data communicated via one or more authenticated user-specific accounts is retrieved. In some embodiments, wherein unauthenticated data is downloaded, specific keyword searches are performed, such as variations on the name of the user, including, in some embodiments, misspellings of various names of the enterprise or other search terms likely to recover relevant unauthenticated data from the social media networks.

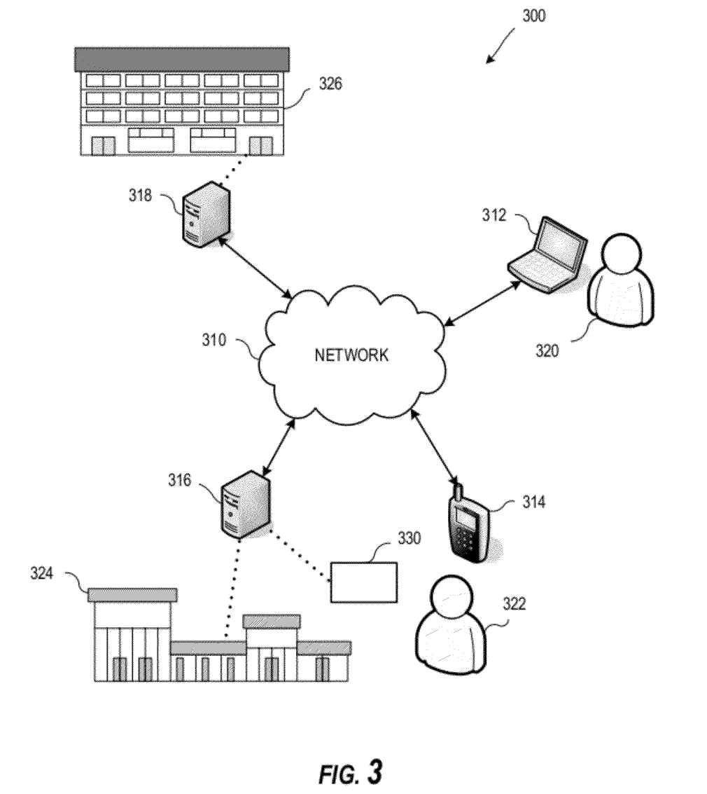

Regarding the block 112, it will be understood that the apparatus can be configured to identify the selected/lead user in any way. For example, in some embodiments, the selected/lead user is identified based on the online data. In other embodiments, for example, the selected/lead user is identified based on online data and other sources of data as detailed below with regard to FIG. 3. As an example, the selected/lead user can be identified based on the online data, financial transaction data, personal data voluntarily submitted by the selected/lead user, data extracted from public records, etc. In some embodiments, a selected/lead user is merely selected before hand, and then it is determined from the social network data whether the user influences other users. In some exemplary embodiments, a selected user associated with a central node is given products or services and the connections to the central node are monitored in order to determine if the selected user displays influential behavior.

It will be understood that the selected/lead user influences the purchase behavior of one or more affiliated users in any way. In some embodiments, the actions of the selected/lead user on the online social media system draw attention to a particular product, such as a service, good, event, etc. For example, in some embodiments, the selected/lead user can generate and entry such as a product review, post a comment regarding a product, create a group, create an invite, review a business, and the like. It will be understood that the purchase behavior includes action and/or decisions relating to purchasing a product, abstaining from purchasing a product, purchasing a product within a certain time period, a purchase price, purchasing a product at a particular store, purchase methods (e.g., credit card payment, online purchases, etc.), modification of the product to be purchased, or any other behavior associated with making a purchase. It will be further understood that the product as used herein includes any tangible or intangible item, any service or good, a voucher, credit, or coupon for a service or good, gifts, and the like.

Regarding the block 114, the apparatus can be configured to send an offer to the selected user and/or the one or more affiliated users in any way. In some embodiments, for example, the apparatus can be configured to deliver the offer to the selected user's and/or affiliated user's social media account, a bank account, email, text, mail, or by any electronic or non-electronic method. As another example, in some embodiments, the offers are delivered automatically. As still another example, in some embodiments, the user can opt-in to accept a product or service. For example, a user can create a wish list of products or services on the social network, and opts-in to receive the listed product or service based on certain network settings, position in the social network, reviews of other in the social network, etc. It will be understood that the offer can be an incentive to purchase a product; a discount; cash back; a rebate; favorable interest rate for a bank account, credit card, or loan; gift certificates; points that can be traded for a product or service; and etc.

In FIG. 1B, a general process flow 100B of an apparatus for analyzing social media behavioral influences is provided, in accordance with an embodiment of an invention. Like the apparatus having process flow 100A, the apparatus having process flow 100B is configured to receive online data associated with users of a social media network. As provided by block 120, the apparatus is configured to store the online data into at least one database. As represented by the block 122, the apparatus is configured to identify an entry generated by at least one of the users, where the entry is related to a product and/or a purchase transaction. As represented by the block 124, the apparatus is further configured to determine the level of interest to the entry generated by an affiliated user. As represented by the block 126, the apparatus having the process flow 100B is configured to identify a selected/lead user, where the selected/lead user at least in part influences the purchase behavior of the affiliated user based on the level of interest. And like the apparatus having the process flow 100A, the apparatus having the process flow 100B is further configured to send an offer to the selected/lead user and/or the affiliated user.

With regard to the block 120, the apparatus is configured to store the online data into at least one database in any way. In some embodiments, for example, the apparatus can be configured to store all of the online data into at least one database for further processing. As another example, in some embodiments, the apparatus is configured to separate, filter, or otherwise process the online data into one or more databases.

With regard to the block 122, the apparatus is configured to identify an entry, where the entry is related to a product and/or purchase transaction in any way. It will be understood that the entry includes a status update, a comment, a post, a response, a link, a video, a picture, a note, a like or dislike, a message, an email, a product review, a private entry, a public entry, a limited public entry, an invitation, online financial transactions, and the like. For example, in some embodiments, the apparatus is configured to search the online data using predetermined search criteria. In some embodiments, the search criteria includes key terms or phrases, images, video, or other electronic data related to a particular brand, business, subject, product identifier, service, and the like. As another example, in some embodiments, the apparatus is configured to search the online data based on the search criteria using search programs or applications that operate by algorithmic and/or human input. The apparatus can be configured to search using various data searching techniques such as Boolean, search strings, clustering, classifications, regression, associate rule learning, statistical data analysis, search associated formulas and calculations (e.g., feature vectors), and the like.

In one example, the apparatus may be configured to: scan the online data to identify the term “automobile” or terms associated with automobile such as “car” or “SUV;” to identify a brand associated with the term automobile such as “Ford;” and identify a model of automobile or phrases associated with automobiles such as “fuel efficient” or “four door.” As another example, in some embodiments, the apparatus is configured to identify groups, discussion boards, posted links, articles, applications and other entries that are categorized as entries related to sales and/or purchases of a service or good (e.g., product pages, sale items, product reviews, etc.).

Regarding the block 124, the apparatus can be configured to determine the level of interest to the entry in any way. For example, in some embodiments, the apparatus is configured to measure the number of responses to the entry generated by the affiliated user. As another example, in some embodiments, the apparatus is configured to determine the number of times the entry and/or postings associated with the entry is viewed. For example, the apparatus may be configured to count the number of times one or more users click on a link associated with the entry. As still another example, in some embodiments, the apparatus is configured to search the content of the responses connected to the entry. In an exemplary embodiment, the apparatus is configured to determine if the responses to the entry are positive (e.g., a “like” response to the entry).

With regard to the block 126, it will be understood that in some embodiments the apparatus is configured to identify a selected/lead user based on the level of interest in any way. For example, in some embodiments, the apparatus is configured to identify the selected/lead user based on the number of responses generated by affiliated users. It will be understood that the response includes any comment, post, message, or action made by the affiliated users due to the entry. Examples of the response include posting a comment to the entry, sharing or forwarding the entry, and the like. As another example, in some embodiments, the apparatus is configured to identify the selected/lead user based on the number of times the entry is viewed. In one specific example, that apparatus may determine that a user that generates an entry in five social media networks has a higher level of interest in the entry than a user that only generates an entry in one social media network. As another specific example, the apparatus may determine that a user that has 1000 followers or connections on a social media network has a higher interest level to the generated entry than a user that only has 100 followers or connections on a social media network. In still another example, in some embodiments, the apparatus is configured to modify the reward based on the level of interest in the entry. The apparatus, for example, may increase the amount of a discount or send an additional discount to the user as the number of responses to the entry increases.

In FIG. 1C, a general process flow 100C of an apparatus for analyzing social media behavioral influences is provided, in accordance with an embodiment of an invention. As represented by the block 130, the apparatus having the process flow 100C is configured to receive online data associated with users of a social media network and financial transaction data associated with the users. As provided by block 132, the apparatus is configured to store the online data and/or financial data into at least one database. As represented by the block 134, the apparatus is configured to compare the online data and/or the financial transaction data. Like the apparatus having the process flow 100A, the apparatus having the process flow 100C is configured to identify a selected/lead user, where the selected/lead user influences the purchase behavior of at least one affiliated user, as represented by the block 112, and send an offer to the selected/lead user and/or the affiliated user as provided in the block 114.

With regard to the block 130, it will be understood that the apparatus is configured to receive online data and financial transaction data in any way. With regard to the block 132, it will be understood that the apparatus is configured to store the online data and/or financial transaction data into a database in anyway. In some embodiments, the apparatus is configured to receive the online data as described above with regard to FIG. 1A, and store the online data and/or financial transaction data into a database as described above with regard to FIG. 1B. It will be understood that the financial transaction data as used herein includes purchase transactions, purchase data associated with a bank account, a credit card, a check, a money order, or any other form of payment, a receipt, a property title record, a bill, investments, and the like. It will be further understood that the financial transaction data further includes data associated with debt repayment, retirement plans, credit cards, debit cards, alimony, loans, credit history records, bank accounts, tax records, bankruptcy filings, judgments, public records, and the like. The financial transaction data includes data extending over a specific time period (e.g., two years, one month, one week, etc.) and predicted future financial transaction trends that are extracted from the financial transaction data (e.g., future earnings, future loan payments, etc.).

In some embodiments, for example, the apparatus is configured to receive purchase data from one or more businesses. It will be understood that the one or more businesses includes businesses where a purchase transaction is made by the user, businesses where goods or services are sold, third party businesses that collect purchase transaction data from the one or more businesses, and the like. It will be further understood that the purchase data includes purchases made electronically, over the phone, in person, or by any other means. As another example, in some embodiments, the apparatus is configured to receive purchase data from the one or more users. For example, the apparatus can be configured to receive purchase information (e.g., a proof of purchase, receipt, bill, etc.) from the one or more users via an online bank account, email, text, phone, or any other electronic or non-electronic method. In some embodiments, for example, the apparatus is configured to receive global positioning system (gps) latitudinal and longitudinal coordinates and timestamp data associated with a mobile device to determine when and where a purchase is made using the mobile device.

Regarding the block 134, it will be understood that the apparatus is configured to compare the online data and/or the financial transaction data in any way. For example, in some embodiments, the apparatus is configured to compare the online data with the financial transaction data to determine purchase transaction trends. As another example, in some embodiments, the apparatus is configured to match an entry generated by the one or more users of the social media network related to a product with a purchase transaction associated with that entry based on a predetermined comparison rule. As a specific example, the apparatus may be configured to determine that an entry relating to a specific product generated by the user matches to a purchase of the same product by the affiliated user.

It will be understood that the comparison rule includes the number of affiliated users that purchase the same or similar product as the user, the time period of the purchase by the affiliated user, the business or location where the affiliated user purchased the product, whether the affiliated user has purchased the same or similar products in the past, the type of product purchased by the user or affiliated user, the preponderance of purchase occurrences, and/or degree of separation (e.g., purchases made by third degree friends of the user). In this way, the apparatus can determine the level or likelihood of influence by a user. For example, an affiliated user who purchases the same product as the user within a week of the user's purchase may be more likely to be influenced by the user than an affiliated user who purchases the same product two years after the user's purchase. As another example, an affiliated user who purchases the same obscure or customized product (e.g., a limited edition, out of print book) as the user is more likely to be influenced by the user than an affiliated user who purchases the same ubiquitous or popular product as the user (e.g., a newly released best selling book).

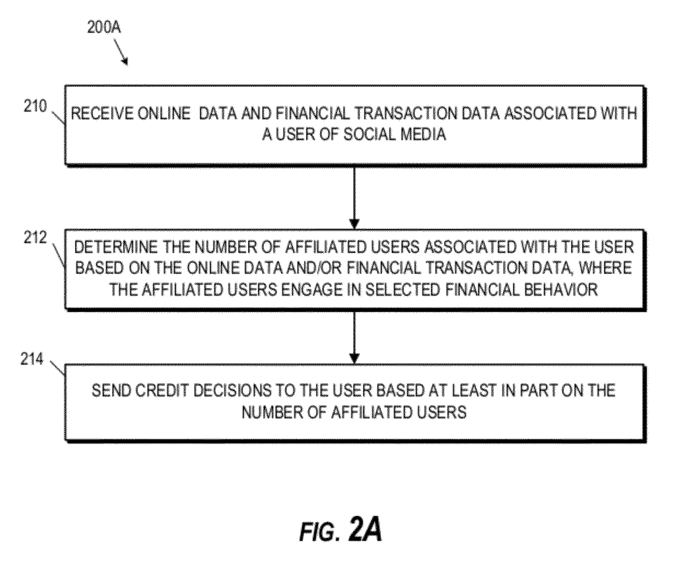

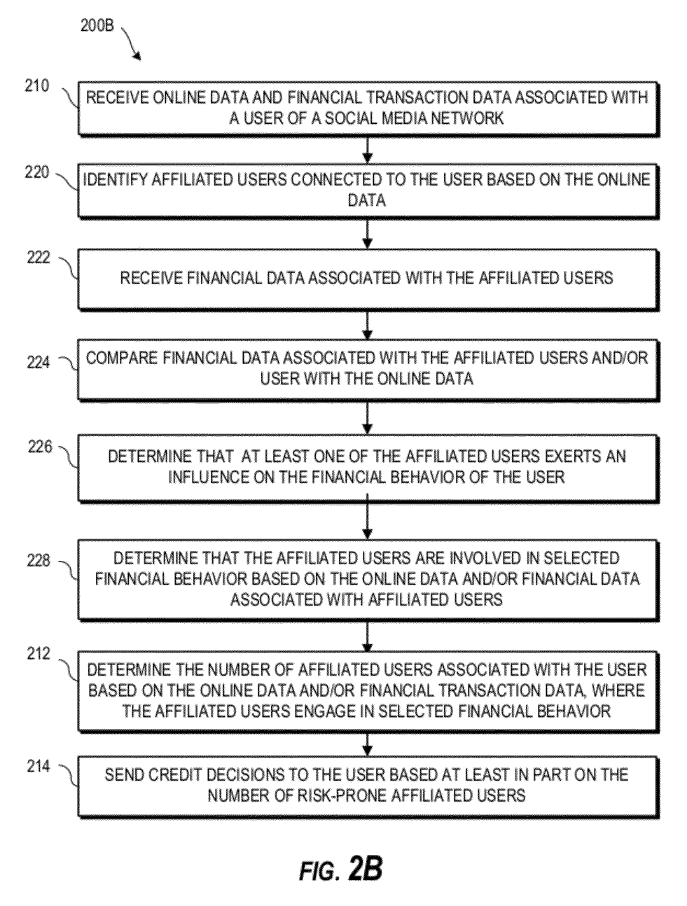

Referring to FIG. 2A, a general process flow 200A of an apparatus for analyzing social media behavioral influences is provided, in accordance with an embodiment of an invention. As represented by the block 210, the apparatus having the process flow 200A is configured to receive online data and financial data associated with a user of a social media network. As provided by block 212, the apparatus is configured to determine the number of affiliated users associated with the user based on the online and/or financial transaction data, where the affiliated users engage in selected financial behavior, such as either responsible or risky financial behavior. As represented by the block 214, the apparatus is configured to send credit decisions to the user based at least in part on the number of affiliated users.

Regarding the block 210, it will be understood that the apparatus is configured to receive the online data and financial transaction data in any way. It will be further understood that the apparatus is configured to receive the online data and financial transaction data as described above with regard to FIGS. 1A and 1C. Regarding the block 212, it will be understood that the apparatus is configured to determine the number of affiliated users, where the affiliated users engage in a selected financial behavior in any way. For example, in some embodiments, the apparatus is configured to identify affiliated users engaging in risky financial behavior based on the entries generated by the affiliated users on the social media network. It will be understood that risky financial behavior includes actions or inactions that may cause short term and/or long term financial instability to the individual engaging is such actions or to others associated with the individual. Examples of risky financial behavior include: failing to timely pay debts; increasing debt or expenses; overdrawing a bank account; decreasing income; promoting or engaging in fraudulent investments; etc. As another example, in some embodiments, the apparatus is configured to determine the degree of the risky financial behavior based on predetermined factors. The predetermined factors include the time period in which the affiliated user is engaged in the risky financial behavior; the amount of debt associated with the behavior; the credit score; the debt to income/savings ratio of the user; timeliness of debt repayment, and the like. For example, the apparatus may send the user a less favorable credit decision upon determination that the affiliated users engage in highly risky financial behavior.

As opposed to reviewing affiliated users with risky financial behavior, the apparatus could identify affiliated users with favorable financial behavior and their potential influence on a selected user. In this embodiment, the apparatus could be configured to identify affiliated users engaging in favorable financial behavior based on the entries generated by the affiliated users on the social media network. Favorable financial behaviors could include actions or inactions that may cause short term and/or long term financial benefits to the individual engaging is such actions or to others associated with the individual. Examples include: timely debt payments; decreasing debt or expenses; increasing income; participating in favorable investments; saving money to reach a financial goal (e.g., saving for college, a car, or a trip), etc. As another example, in some embodiments, the apparatus is configured to determine the degree of the financial behavior based on predetermined factors. The predetermined factors include the time period in which the affiliated user is engaged in the financial behavior; the amount of debt associated with the behavior; the credit score; the debt to income/savings ratio of the user; timeliness of debt repayment, and the like. For example, the apparatus may send the user a more favorable credit decision upon determination that the affiliated users engage in favorable financial behavior.

Regarding the block 214, it will be understood that the apparatus is configured to send credit decisions to the user in any way. It will be understood that the credit decision includes a negative or positive response to a request; a modification of the terms of a request; a solicited or unsolicited offer, of any combination thereof. Examples of the credit decision include responses to a request and/or offers associated with: a loan; a bank account; a debt; credit; an investment; a credit card; a debit card; a modification to a financial agreement; and the like. For example, in some embodiments, the apparatus is associated with a financial institution, a business, a trusted third party agent, or any other entity. In some embodiments, the apparatus is configured to send the credit decision via phone, text, email, mail, or any other electronic or non-electronic means. In one embodiment, the apparatus is configured to send the credit decision to an account associated with a social media network. As another example, in some embodiments, the apparatus is configured to modify the credit decision based, at least in part, on the number of affiliated users associated with the user, where the affiliated users are involved in risky financial behavior. For example, the apparatus may deny a loan request or lower the amount of a loan upon determination that the number of affiliated users are above a certain number or percentage. As still another example, in some embodiments, the apparatus is configured to base the credit decision, at least in part, on the financial transaction data associated with the user.

As still another example, in some embodiments, the apparatus is configured to modify the credit decision based at least in part on the level of interactive communication between the user and the affiliated user. In some embodiments, the apparatus is configured to modify the credit decision based at least in part on the number of affiliated users that are directly connected to the user. As a specific example, the apparatus may be configured to base, at least in part, the credit decision on “friends” of the user and not on second degree friends, or friends that are further removed from the user.

Referring to FIG. 2B, a general process flow 200B of an apparatus for analyzing social media behavior is provided, in accordance with an embodiment of an invention. Like the apparatus having process flow 200A, the apparatus having process flow 200B is configured to receive online data and financial transaction data associated of a user of social media as represented by the block 210. As represented by the block 220, the apparatus is configured to identify affiliated users connected to the user based on the online data. As represented by the block 222, the apparatus is configured to receive financial data associated with the affiliated users. As provided by block 224, the apparatus is configured to compare the financial data associated with the affiliated user and/or user with the online data. As represented by the block 226, the apparatus is configured to determine that at least one of the affiliated users exerts an influence on the financial behavior of the user. As represented by the block 228, the apparatus is configured to determine that the affiliated users are involved in risky financial behavior based on the online data and/or financial data associated with the affiliated users. Like the apparatus having process flow 200A, the apparatus having process flow 200B is configured to determine that the number of affiliated users associated with the user, where the affiliated users are involved in risky financial behavior, as represented by the block 212; and the apparatus is configured to send credit decisions to the user based, at least in part, on the number of affiliated users, as represented by the block 214.

Regarding the block 220, the apparatus is configured to identify the affiliated users connected to the user in any way. For example, in some embodiments, the apparatus can be configured to determine direct or indirect friends or contacts of the user based on the online data. As another example, in some embodiments, the apparatus can be configured to identify members of groups or networks associated with the user.

Regarding the block 222, the apparatus is configured to receive financial data associated with the affiliated users in any way. It will be understood that the apparatus is configured to receive the data from the affiliated user, from a business, a business associate of the affiliated user, a trusted third party, and the like. Further, in some embodiments, the apparatus is configured to receive the financial data associated with the affiliated user by mail, phone, email, text, or any other electronic or non-electronic means. For example, in some embodiments, the apparatus is configured to receive the financial data associated with the affiliated user by accessing a financial account (e.g., a checking account) of the affiliated user.

Regarding the block 224, the apparatus is configured to compare the financial data associated with the affiliated user and/or user with the online data in any way. For example, in some embodiments, the apparatus is configured to match a purchase amount, a product, a brand, a store, a service, or any financial data with the online data (e.g., an entry, a response, a message, a profile, etc.). As another example, in some embodiments, the apparatus conducts a keyword search of the online data to extract certain results and matches the results of the search with the terms contained in the financial data. As still another example, in some embodiments, the apparatus is configured to search the key terms and/or phrases using search programs or applications that operate by algorithmic and/or human input. The apparatus can be configured to search using various data searching techniques such as Boolean, search strings, clustering, classifications, regression, associate rule learning, statistical data analysis, search associated formulas and calculation (e.g., feature vectors), and the like.

Regarding the block 226, the apparatus is configured to determine that at least one of the affiliated users exerts an influence on the financial behavior of the user in any way. For example, in some embodiments, the apparatus is configured to determine a link between a key term in the financial data associated with the user (e.g., a purchase transaction) and a matching term in the online data (e.g., an interactive communication between the user and at least one affiliated user). In this way, the apparatus may determine that the user failed to pay a debt, for example, as a result of a message, response, or other entry generated by at least one of the affiliated users. As another example, in some embodiments, the apparatus is configured to modify the credit decision based at least in part on the extent of the influence. In some embodiments, the apparatus is configured to base the extent of the influence on any number of determinations. It will be understood that the determinations include the legal, social, financial, or familial relationship of the user and the affiliated user; shared financial interests; connected financial transactions; and the like. The apparatus, in some embodiments, is further configured to track the financial transactions of the legally related affiliated user to determine the extent of the influence on the user's financial behavior. For example, the apparatus may be configured to determine that the extent of the influence is much greater if the affiliated user is a financial advisor or business partner of the user than if the affiliated user is a classmate of the user.

In some exemplary embodiment, the apparatus is configured to establish that a legal relationship exists between the user and the affiliated user. Legal relationships include spouses, business partners, co-owners, agent/client, landlord/tenant, provider/dependent, parent/child, financial advisor/client, employer/employee, board members, etc. The apparatus, in some embodiments, is also configured to establish non-legal relationship to determine the extent of the influence. Non-legal relationships include friends, classmates, colleagues living in the same city, co-workers, relatives, and the like. As another example, in some embodiments, the apparatus is configured to determine that a connection exists between the financial transactions of the user and the financial transaction of the affiliated user, where the connection comprises a shared financial interest. Examples of the shared financial interest include contracts, a shared business, a shared bank account, a shared debt, a property interest, etc.

It will be further understood that, in some embodiments, the apparatus is configured to determine that at least one of the affiliated user exerts an influence on the financial behavior of the user base solely on the financial data. For example, in some embodiments, the apparatus is configured to determine a certain threshold of multiple same day purchases occurring at a single physical location. For example, the apparatus can determine that a user and one or more affiliated users purchased a product fifty times a year, on the same day, at the same location. In this way the apparatus is configured to determine that a social connection exists. As another example, the apparatus can be further configured to track purchases made within a short period (e.g., a week) and same day purchases to determine the strength of a social connection. Still further, in some embodiments, the apparatus is configured to determine that the affiliated user influences the financial behavior of the user by determining that the user purchases the same or similar product within a short period (e.g., a day, a week, etc.) after the affiliated user purchases the product.

Regarding the block 228, the apparatus is configured to determine that the affiliated users are involved in selected financial behavior in any way. For example, in some embodiments, the apparatus is configured to determine that the affiliated user is involved in risky financial behavior based on one or more entries generated by the affiliated users on the social media network. For example, the apparatus may extrapolate financial information from the one or more entries associated with the affiliated users, such as timeliness of loan repayment. In other embodiments, for example, the apparatus is configured to combine information extrapolated from the online data with the financial transaction data associated with the affiliated users to determine that at least one of the affiliated users are involved in risky financial behavior. As another example, in some embodiments, the apparatus is configured to determine that at least one of the affiliated users is involved in a selected financial behavior based solely on the financial data associated with the affiliated users (e.g., a credit report, a savings account, credit card bills, etc.).

Referring now to FIG. 3, a system 300 is provided for analyzing social media behavioral influences is provided, in accordance with an embodiment of an invention. As illustrated, the system 300 includes a network 310, a user device 312, an affiliated user device 314, a purchase device 316, and a receiving device 318. Also shown are a user 320 associated with the user device 312, an affiliated user 322 associated with the affiliated user device 314, a business 324 associated with the purchase device 316, and a financial institution 326 associated with the receiving device 318.

As shown in FIG. 3, the user device 312, the affiliated user device 314, the purchase device 316, and the receiving device 318 are each operatively and selectively connected to the network 310, which may include one or more separate networks. In addition, the network 310 may include one or more interbank networks, telephone networks, telecommunication networks, local area networks (LANs), wide area networks (WANs), and/or global area networks (GANs) (e.g., the Internet, etc.). It will also be understood that the network 310 may be secure and/or unsecure and may also include wireless and/or wireline technology.

In the illustrated embodiment, the user 320 uses the user device 312 (e.g., a laptop) to access a social media network and generate an entry on the social media network. For example, in some embodiments, the user enters a security code and user name to log onto the social media network. The affiliated user 322, in an exemplary embodiment, views and/or responds to the entry made by the user 320 using the affiliated user device 314 (e.g., a smart phone). In some embodiments, the affiliated user 322 decides to purchase a product based at least partially on the entry using a form of payment (e.g., a credit card 330). The purchase device 316 (e.g., a point of sales device, a server, etc.), in some embodiments, records the financial transaction data associated with the purchase and sends the financial transaction data to the receiving device 318. In other embodiments, the receiving device 318 receives the financial transaction directly from the affiliated user 322 (e.g., via an online checking account that the affiliated user 322 maintains with the financial institution 326). As another example, in some embodiments, the receiving device 318 receives online data associated with the user 320 and/or affiliated user 322 of the social media network.

In FIG. 4, a system 400 is provided for analyzing social media behavioral influences is provided, in accordance with an embodiment of an invention. As illustrated, the system 400 includes the network 310, a user apparatus 410, an affiliated user apparatus 420, an analysis apparatus 430, and an offer apparatus 440. The user apparatus 410, the affiliated user apparatus 420, the analysis apparatus 430, and the offer apparatus 440 are each operatively and selectively connected to the network 310.

It will be understood that, in accordance with some embodiments of the present invention, that the analysis apparatus 430, and/or the offer apparatus 440 can each be operated, serviced, controlled, and/or maintained (collectively herein “maintained” for simplicity) by the same business (not shown). For example, in some embodiments, the analysis apparatus 430, and/or the offer apparatus 440 are each maintained by the same financial institution (e.g., the financial institution 326 of FIG. 3). As another example, in some embodiments, the analysis apparatus 430 and offer apparatus 440 are incorporated into one system. Alternatively, in some of these embodiments, the analysis apparatus 430 is maintained by one business or individual and the offer apparatus 440 is maintained by a second business or individual.

The user apparatus 410 may include any computerized apparatus that can be configured to perform any one or more of the functions of the user apparatus 410 described and/or contemplated herein. In some embodiments, for example, the user apparatus 410 may include the user device 312, one or more personal computer systems, mobile phones, personal digital assistants, public kiosks, point of sale devices, network devices, and/or the like. As illustrated in FIG. 4, in accordance with some embodiments of the present invention, the user apparatus 410 includes a communication interface 412, a processor 414, a memory 416 having a browser application 417 and a social media application 418 stored therein, and a user interface 419. In such embodiments, the communication interface 412 is operatively and selectively connected to the processor 414, which is operatively and selectively connected to the user interface 419 and the memory 416.

Each communication interface described herein, including the communication interface 412, generally includes hardware, and, in some instances, software, that enables a portion of the system 400, such as the user apparatus 410, to transport, send, receive, and/or otherwise communicate information to and/or from the communication interface of one or more other portions of the system 400. For example, the communication interface 412 of the user apparatus 410 may include a modem, server, electrical connection, and/or other electronic device that operatively connects the user apparatus 410 to another electronic device, such as the electronic devices that make up the analysis apparatus 430.

Each memory device described herein, including the memory 416 for storing the social media application 418 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 4, the memory 416 includes the browser application 417 and the social media application 418. In some embodiments, the browser application 417 includes a web browser application and/or another application (e.g., an email application) for communicating with the affiliated user apparatus 420, the offer apparatus 430 and/or other portions of the system 400. For example, in some embodiments, the user 320 uses the browser application 417 to send the online data and/or financial transaction data to the analysis apparatus 430. As another example, in some embodiments, the user 320 uses the browser application 417 to receive and/or request a credit decision issued by the analysis apparatus 430. It will be understood that, in some embodiments, the social media application 418 is configured for accessing one or more social media networks, and may be used in conjunction with the browser application 417 in accordance with embodiments disclosed herein. For example, the social media application 418 is configured to generate, forward and/or modify an entry, communicate with the affiliated user, store online data, share files, play games, track and/or search information, tag or link websites, instant message, text chat, and the like. In some embodiments, the applications 417 and/or 418 include computer-executable program code portions for instructing the processor 414 to perform one or more of the functions of the browser application 417 and/or social media application 418 described and/or contemplated herein. In some embodiments, the browser application 417 and/or social media application 418 may include and/or use one or more network and/or system communication protocols.

Also shown in FIG. 4 is the user interface 419. In some embodiments, each user interface, including the user interface 419, includes one or more user output devices, such as a display and/or speaker, for presenting information to the user apparatus 410 and/or some other user. In some embodiments, the user interface 419 and each user interface described herein includes one or more user input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user apparatus 410 and/or some other user. In some embodiments, the user interface 419 includes the input and display devices of a personal computer, such as a keyboard and monitor, that are operable to receive and display information associated with the electronic file.

Also shown in FIG. 4 is the affiliated user apparatus 420, which may include any computerized apparatus that can be configured to perform any one or more of the functions of the affiliated user apparatus 420 described and/or contemplated herein. In some embodiments, for example, the affiliated user apparatus 420 may include the affiliated user device 314 illustrated in FIG. 3, one or more personal computer systems, mobile phones, personal digital assistants, public kiosks, point of sale devices, network devices, and/or the like. As illustrated in FIG. 4, in accordance with some embodiments of the present invention, the affiliated user apparatus 420 includes a communication interface 422, a processor 424, a memory 426 having a browser application 427 and a social media application 428 stored therein, and a user interface 429. In such embodiments, the communication interface 422 is operatively and selectively connected to the processor 424, which is operatively and selectively connected to the user interface 429 and the memory 426.

In some embodiments, the browser application 427 includes a web browser application and/or another application (e.g., an email application) for communicating with the user apparatus 410, the offer apparatus 430 and/or other portions of the system 400. For example, in some embodiments, the affiliated user 322 uses the browser application 427 to send the online data and/or financial transaction data to the analysis apparatus 430. As another example, in some embodiments, the affiliated user 322 uses the browser application 427 to purchase a product.

It will be understood that, in some embodiments, the social media application 428 is configured for accessing one or more social media networks, and may be used in conjunction with the browser application 427 in accordance with embodiments disclosed herein. For example, the social media application 428 is configured to generate, forward and/or modify an entry, communicate with the affiliated user, store online data, share files, play games, track and/or search information, tag or link websites, instant message, text chat, and the like. In some embodiments, the applications 427 and/or 428 include computer-executable program code portions for instructing the processor 424 to perform one or more of the functions of the browser application 427 and/or social media application 428 described and/or contemplated herein. In some embodiments, the browser application 427 and/or social media application 428 may include and/or use one or more network and/or system communication protocols.

FIG. 4 also illustrates the analysis apparatus 430, in accordance with an embodiment of the present invention. The analysis apparatus 430 may include any computerized apparatus that can be configured to perform any one or more of the functions of the analysis apparatus 430 described and/or contemplated herein. In accordance with some embodiments, for example, the analysis apparatus 430 may include the receiving device 318 illustrated in FIG. 3, one or more servers, mainframes, personal computers, engines, platforms, database systems, front end systems, back end systems, network devices, and/or the like. In some embodiments, such as the one illustrated in FIG. 4, the analysis apparatus 430 includes a communication interface 432, a processor 434, and a memory 436, which includes an analysis application 437 and an analysis datastore 438 stored therein. As shown, the communication interface 432 is operatively and selectively connected to the processor 434, which is operatively and selectively connected to the memory 436.

It will be understood that, in some embodiments, the analysis application 437 is configured to initiate, perform, and/or facilitate one or more of the portions of one or more of the embodiments described and/or contemplated herein, such as, for example, one or more of the portions of the process flows 100A, 100B, 100C, 200A and/or 200B described herein. For example, in some embodiments, the analysis application 437 is configured to receive online data associated with users of a social media network. Additionally, in some embodiments, analysis application 437 is configured to identify a selected/lead user, where the selected/lead user influences the purchase behavior of an affiliated user based on the online data. For example, in some embodiments, the analysis application 437 identifies an entry generated by the users, where the entry is linked to a financial transaction; and also determines the level of interest to the entry generated by an affiliated user. As still another example, in some embodiments, analysis application 437 is configured to receive financial transaction data associated with users of a social media network; and compare the online data with the financial transaction data.

Additionally or alternatively, in some embodiments, analysis application 437 is configured to determine the number of affiliated users associated with the user based on the online data and/or financial transaction data, where the affiliated users engage in selected financial behavior. Further, in some embodiments, the analysis application 437 sends credit decisions to the user based at least in part on the number of affiliated users. It will be also understood that, in some embodiments, the analysis application 437 is configured to communicate with one or more other portion of the system 400, such as, for example, the offer apparatus 440, user apparatus 410, and/or affiliated user apparatus 420. It will be further understood that, in some embodiments, the analysis application 437 includes computer-executable program code portions for instructing the processor 434 to perform any one or more of the functions of the analysis application 437 described and/or contemplated herein. In some embodiments, the analysis application 437 may include and/or use one or more network and/or system communication protocols.

In addition to the analysis application 437, the memory 336 also includes the analysis datastore 438. It will be understood that the analysis datastore 438 can be configured to store any type and/or amount of information. For example, in some embodiments, the analysis datastore 438 includes information associated with one or more offer apparatuses 440 and/or user apparatuses 410, one or more users 320, the affiliated user apparatus 420, confidential information, online data, financial transaction data, search results, key words, search strings, formulas, credit decisions, and the like. In some embodiments, the analysis datastore 438 additionally or alternatively stores information associated with the offer.

It will be understood that the analysis datastore 438 may include any one or more storage devices, including, but not limited to, datastores, databases, and/or any of the other storage devices typically associated with a computer system. It will also be understood that the analysis datastore 438 may store information in any known way, such as, for example, by using one or more computer codes and/or languages, alphanumeric character strings, data sets, figures, tables, charts, links, documents, and/or the like. Further, in some embodiments, the analysis datastore 438 may include information associated with one or more applications, such as, for example, the analysis application 437. For example, in some embodiments, the analysis datastore 438 includes information associated with the user 320, affiliated user 322, and/or apparatuses 410 and 420. It will also be understood that, in some embodiments, the analysis datastore 438 provides a substantially real-time representation of the information stored therein, so that, for example, when the processor 434 accesses the analysis datastore 438, the information stored therein is current or substantially current.

Further, FIG. 4 also illustrates the offer apparatus 440, in accordance with an embodiment of the present invention. The offer apparatus 440 may include any computerized apparatus that can be configured to perform any one or more of the functions of the offer apparatus 440 described and/or contemplated herein. In accordance with some embodiments, for example, the offer apparatus 440 may include one or more personal computer systems, mobile phones, personal digital assistants, public kiosks, network devices, and/or the like. In some embodiments, such as the one illustrated in FIG. 4, the offer apparatus 440 includes a user interface 449, communication interface 442, a processor 444, and a memory 446, which includes an offer application 448 stored therein. As shown, the communication interface 442 is operatively and selectively connected to the processor 444, which is operatively and selectively connected to the user interface 449 and the memory 446.

It will be understood that, in some embodiments, the offer application 448 is configured to initiate, perform, and/or facilitate one or more of the portions of one or more of the embodiments described and/or contemplated herein, such as, for example, one or more of the portions of the process flows 100A, 100B, 100C, 200A, and/or 200B described herein.

For example, in some embodiments, the offer application 448 includes one or more applications configured to send an offer to the user 320 and/or affiliated user 322. It will be also understood that, in some embodiments, the offer application 448 is configured to communicate with one or more other portion of the system 400, such as, for example, the analysis apparatus 430, the user apparatus 410, and/or the affiliated user apparatus 420. It will be further understood that, in some embodiments, the offer application 448 includes computer-executable program code portions for instructing the processor 444 to perform any one or more of the functions of the offer application 448 described and/or contemplated herein. In some embodiments, the offer application 448 may include and/or use one or more network and/or system communication protocols.

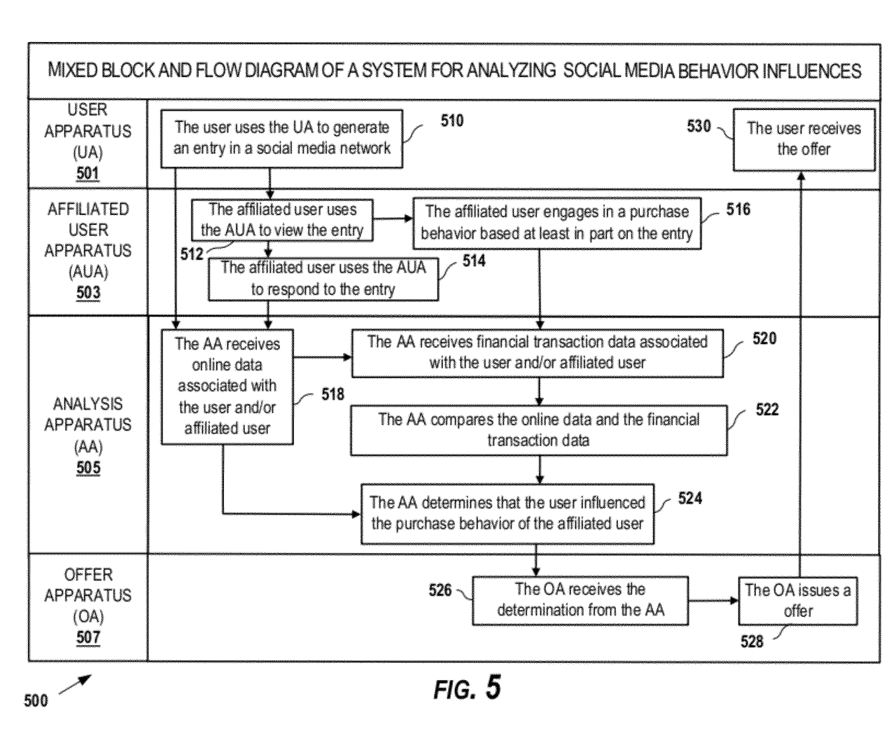

It will also be understood that the system 400 (and/or one or more portions of the system 400) may include and/or implement any embodiment of the present invention described and/or contemplated herein. For example, in some embodiments, the system 400 (and/or one or more portions of the system 400) is configured to implement any one or more of the embodiments of the process flows 100A-100C described and/or contemplated herein in connection with FIGS. 1A-1C, any one or more of the embodiments of the process flows 200A-200B described and/or contemplated herein in connection with FIGS. 2A-2B, any one or more of the embodiments of the system 300 contemplated herein with connection to FIG. 3, and or any one or more of the embodiments described and/or contemplated herein in connections with FIGS. 5-7.

As a specific example, in accordance with an embodiment of the present invention, (1) the analysis apparatus 430 is configured to receive online data associated with users of a social media network, as represented by the block 110 in FIG. 1A; (2) the analysis apparatus 430 is configured to identify a selected/lead user based on the online data, where the selected/lead user influences the purchase behavior of an affiliated user, as illustrated by the block 112 in FIG. 1A; (3) the analysis apparatus 430 and/or the offer apparatus 440 are configured to send an offer to the selected/lead user and/or the affiliated user, as represented by the block 114 in FIG. 1A. It will be understood that, in accordance with some embodiments, the analysis apparatus 430, the offer apparatus 440, the user apparatus 410, and/or the affiliated user apparatus 420, are each configured to send and/or receive one or more instructions to and/or from each other, such that an instruction sent from a first apparatus to a second apparatus can trigger that second apparatus to perform one or more portions of any one or more of the embodiments described and/or contemplated herein.

As another specific example, in accordance with an embodiment of the present invention, (1) the analysis apparatus 430 is configured to receive online data and financial transaction data associated with a user of a social media network, as represented by the block 210 in FIG. 2A; (2) the analysis apparatus 430 is configured to determine the number of affiliated users associated with the user based on the online data and/or financial transaction data, where the affiliated users engage in selected financial behavior, as illustrated by the block 212 in FIG. 2A; (3) the analysis apparatus 430 is configured to send a credit decision to the user based at least in part on the number of affiliated users, as represented by the block 214 in FIG. 2A.

Referring now to FIG. 5, a mixed block and flow diagram of a system 500 for analyzing social media behavioral influences is provided, in accordance with a more-detailed embodiment of the present invention. As shown, the system 500 includes a user apparatus 501 (e.g., the user apparatus 410 shown in FIG. 4, etc.), an affiliated user apparatus 503 (e.g., the affiliated apparatus 420 of FIG. 4, etc.), an analysis apparatus 505 (e.g., the analysis apparatus 430 shown in FIG. 4), and an offer apparatus 507 (e.g., the offer apparatus 440 shown in FIG. 4, etc.). It will be understood that the user apparatus 501 and affiliated user apparatus 503 are operatively and selectively connected to the analysis apparatus 505 and/or the offer apparatus 507 via one or more networks (not shown). It will also be understood that, in accordance with some embodiments, the analysis apparatus 505 is accessible to an analyzer (not shown), the offer apparatus 507 is accessible to an offer user (not shown), the user apparatus 501 is accessible to the user 320, and the affiliated user apparatus 503 is accessible to the affiliated user 322. In some embodiments, the analysis apparatus 505, and the offer apparatus 507 are maintained by the same business (e.g., a retail store, a bank, etc.), and that the analyzer and/or the offer user are employees of that business. In other embodiments, the analysis apparatus 505 is maintained by one business (e.g., a bank), the offer apparatus 507 is maintained by another business (e.g., a trusted third party). It will be understood that the user 320 and/or affiliated user 322 include customers of the one or more businesses maintaining the analysis apparatus 505 and/or offer apparatus 507, members of one or more social media networks, or any other individual or agent affiliated with a social media network.

As shown in FIG. 5, the user uses the user apparatus 501 to generate an entry in a social media network, as represented by the block 510. For example, in some embodiments, the entry is related to a product (e.g., a service or good) and/or a purchase transaction (e.g., a sale at a business, etc.). The affiliated user uses the affiliated user apparatus 503 to view the entry as represented by the block 512. The affiliated user then engages in a purchase behavior based at least in part on the entry, as represented by the block 516, and/or uses the affiliated user apparatus 503 to respond to the entry, as represented by the block 514. For example, in some embodiments, the affiliated user purchases a product based on the entry.

As represented by the block 518, the analysis apparatus 505 receives online data associated with the user and/or affiliated user. The analysis apparatus 505 also receives financial transaction data association with the user and/or affiliated user as represented by the block 520. The analysis apparatus 505 then compares the online data and the financial transaction data as represented by the block 522. Based on the online data and/or the financial transaction data, the analysis apparatus determines that the user influenced the purchase behavior of the affiliated user, as represented by the block 524. As represented by the block 526, the offer apparatus 507 receives the determination from the analysis apparatus 524. For example, in some embodiments, the analysis apparatus sends instructions to the offer apparatus 507 to issue an offer to the user and/or affiliated users. As another example, in some embodiments, the offer apparatus determines the type, amount, issuing method, and/or recipient of the offer. As represented by the block 530, the user received the offer. In some embodiments, the user determines the type, amount, issuing method, and/or recipient of the offer. For example, in some embodiments, the analysis apparatus 505 and/or offer apparatus 507 is configured to receive the user's offer preferences. The user can, for example, choose preferences via an online account, such as a social media account, a bank account maintained by a financial institution, email, text, messaging, telephone, or any other preferred method.

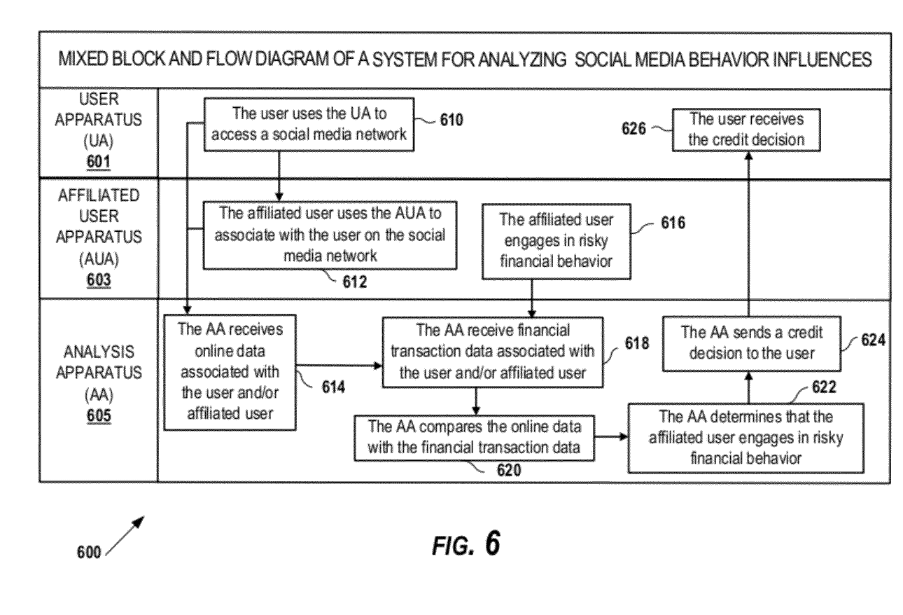

Referring now to FIG. 6, a mixed block and flow diagram of a system 600 for analyzing social media behavioral influences is provided, in accordance with a more-detailed embodiment of the present invention. As shown, the system 600 includes a user apparatus 601 (e.g., the user apparatus 410 shown in FIG. 4, etc.), an affiliated user apparatus 603 (e.g., the affiliated apparatus 420 of FIG. 4, etc.), and an analysis apparatus 605 (e.g., the analysis apparatus 430 shown in FIG. 4). It will be understood that the user apparatus 601 and affiliated user apparatus 603 are operatively and selectively connected to the analysis apparatus via one or more networks (not shown). It will also be understood that, in accordance with some embodiments, the analysis apparatus 605 is accessible to an analyzer (not shown), the user apparatus 601 is accessible to the user 320, and the affiliated user apparatus 603 is accessible to the affiliated user 322.

As shown in FIG. 6, the user uses the user apparatus 601 to access a social media network as represented by the block 610. The affiliated user uses the affiliated user apparatus 603 to associate with the user on the social media network as represented by the block 612. For example, in some embodiments, the affiliated user views or accesses at least a portion of a social media network account of the user. As another example, in some embodiments, the affiliated user and the user are co-members of a social media network In some exemplary embodiments, the affiliated user and user are “friends” on the social media network. As represented by the block 614, the analysis apparatus 605 receives online data associated with the user and/or affiliated user. Further, the affiliated user engages in risky financial behavior, as represented by the block 616, and the analysis apparatus 605 receives financial transaction data associated with the user and/or affiliated user, as represented by the block 618. For example, in some embodiments, the analysis apparatus retrieves the financial transaction data associated with the affiliated user from a third party (e.g., a credit reporting agency). As represented by the block 620, the analysis apparatus 605 compares the online data with the financial transaction data. For example, in some embodiments, the analysis apparatus matches key terms in the financial transaction data with key terms in the online data. As represented by the block 622, the analysis apparatus 605 determines that the affiliated user engages in risky financial behavior. The analysis apparatus 605 then sends a credit decision to the user (e.g., a credit card offer), as represented the block 624. As represented by the block 626, the user receives the credit decision. For example, in some embodiments, the user receives the credit decision via an account associated with social media network.

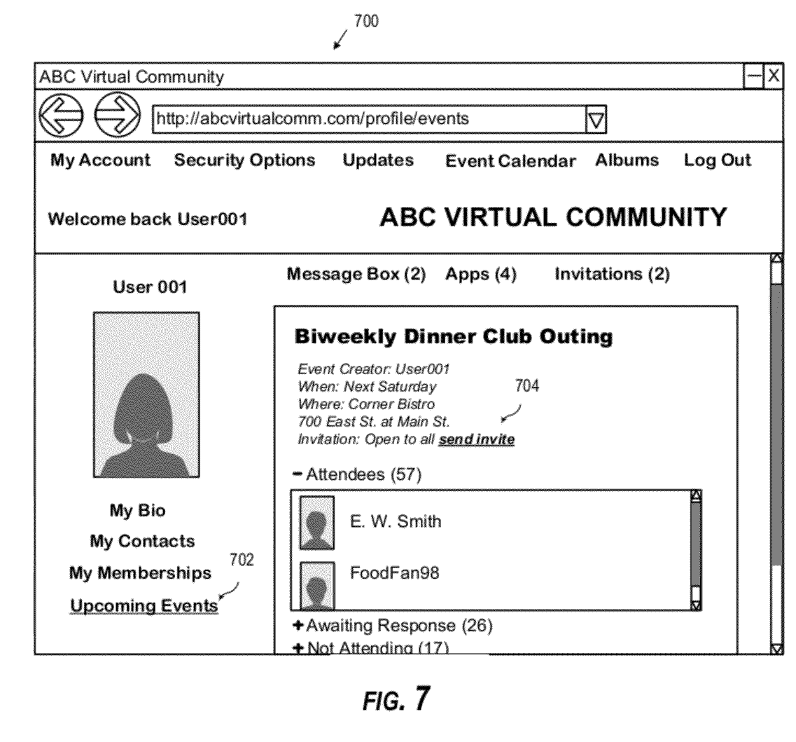

Referring now to FIG. 7, an exemplary graphical user interface (GUI) 700 is provided, in accordance with an embodiment of the present invention. It will be understood that, in some embodiments, the GUI 700 is associated with one or more computer devices. Also, it will be understood that the GUI 700 can be embodied as portions of a software application, portions of a portal application, as intranet pages, as Internet web pages, and/or the like. In addition, it will be understood that, in some embodiments, the apparatus having the process flows 100A-100C, the system 300, and/or the system 400 are configured to implement any one or more of the embodiments of the present invention described and/or contemplated herein in connection with the GUI 700. It will be further understood that, in some embodiments, the apparatus having the process flow 200A and/or the apparatus having the process flow 200B can be configured to modify any one or more of the embodiments of the present invention described and/or contemplated herein in connection with the GUI 700.

Referring now to FIG. 7, an exemplary GUI 700 that may be provided, for example, on a social media network or other online system is illustrated. It will be understood that, in some embodiments, a user accesses a social media network account using security measures. For example, in some embodiments, a user of the social media network enters a security code into a designated field on the social media network in order to access an account. In the illustrated embodiment, the GUI 700 is an exemplary interface where a user can click on the link 702 entitled “Upcoming Events” in a side menu on the left side of the page. Upon selection of this link, the GUI 700 is provided to the user. The GUI 700 displays information related to upcoming events. In the illustrated embodiment, the event is an open invitation event organized by a user. The creator of the event and those invited to the event can click on the link 704 entitled “send invite” to forward the invitation to others. In some embodiments, for example, an analysis apparatus (e.g., the analysis apparatus 430 illustrated in FIG. 4) can receive information detailed in GUI 700 and determine that User 001 at least partially influenced the purchase behavior of at least 57 affiliated users. As another example, the analysis apparatus can further combine the information related to the GUI 700 with financial transaction data of attendees of the event detailed in GUI 700 to determine the number of individuals who engaged in a purchase transaction and the amount of the purchase.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method comprising:
receiving data from one or more social media networks associated with a user;
determining a selected activity of the user associated with the one or more social media networks based on the data using a processor; and
sending an offer to the user based at least in part on the selected activity of the user.

2. The method of claim 1, wherein the selected activity is the number of affiliated users with a social network that are associated with the user and said sending an offer comprises sending an offer to the user if the number of affiliated users associated with the user is greater than or equal to a selected value.

3. The method of claim 1, wherein the selected activity is number of times the user enters postings on the one or more social networks and said sending an offer comprises sending an offer to the user if the number of posts made by the user is greater than or equal to a selected value.

4. The method of claim 1, wherein the selected activity is the number of times that affiliated users to a social network respond to one or more posts entered by the user on the social network and said sending an offer comprises sending an offer to the user if the number of times that affiliated users respond to one or more posts by a user is greater than or equal to a selected value.

5. The method of claim 1, wherein the selected activity is a type of product, service, or event that the user enters one or more postings on the one or more social networks and said sending an offer comprises sending an offer to the user based on the type of product, service, or event that the user entered a posting.

6. The method of claim 1, wherein the selected activity is a number or type of product, service or event that the user has selected on the one or more social networks and said sending an offer comprises sending an offer to the user based on either the number or type or products, services, or events the user selects via the one or more social networks.

7. The method of claim 1, wherein the selected activity is one or more selected users affiliated with one or more social networks that are associated with the user and said sending an offer comprises sending an offer to the user based on the fact that the user is associated with the one or more selected affiliated users.

8. The method of claim 1 further comprising analyzing financial transaction data associated with the user.

9. The method of claim 8, wherein said sending an offer comprises sending an offer to the user based at least in part on the selected activity of the user and the financial data associated with the user.

10. The method of claim 1 further comprising:
analyzing financial transaction data associated with the user and associated with other users affiliated with a social network that are also associated with the user;
determining based at least in part on the financial data whether a selected activity of the user influences the other users to perform the same activity,
wherein sending an offer comprises sending an offer to the user based on determining that the user influences other users.

11. The method of claim 10 wherein said determining comprises determining that other users purchase a product or service or select an event after user has purchased the product or service or selected the event.

12. The method of claim 1 further comprising:
analyzing financial transaction data associated with the user and associated with other users affiliated with a social network that are also associated with the user;
determining based at least in part on the financial data whether a selected activity of one or more of the other users influences the user to perform the same activity,
wherein sending an offer comprises sending an offer to the user based on determining that the user is influenced by one or more of the other users.

13. The method of claim 1 further comprising:
analyzing financial transaction data associated with the user and associated with other users affiliated with a social network that are also associated with the user;
determining based at least in part on the financial data whether one or more of the other users engage in a selected financial behavior;
wherein sending an offer to the user comprises sending an offer regarding a credit decision to the user based at least in part on the user's association with other users in the social network that engage in the selected financial behavior.

14. The method of claim 13 further comprising:
comparing financial transaction data associated with other users with the financial transaction data associated with the user;
determining that at least one of the other users exerts an influence on a financial behavior of the user; and
modifying the credit decision based at least in part on the extent of the influence.

15. An apparatus comprising:
a processing element configured to
receive data from one or more social media networks associated with a user;
determine a selected activity of the user associated with the one or more social media networks based on the data using a processor; and
send an offer to the user based at least in part on the selected activity of the user.

16. The apparatus of claim 15, wherein the selected activity is the number of affiliated users with a social network that are associated with the user and said processing element is configured to send an offer to the user if the number of affiliated users associated with the user is greater than or equal to a selected value.

17. The apparatus of claim 15, wherein the selected activity is number of times the user enters postings on the one or more social networks and said processing element is configured to send an offer to the user if the number of posts made by the user is greater than or equal to a selected value.

18. The apparatus of claim 15, wherein the selected activity is the number of times that affiliated users to a social network respond to one or more posts entered by the user on the social network and said processing element configured to send an offer to the user if the number of times that affiliated users respond to one or more posts by a user is greater than or equal to a selected value.

19. The apparatus of claim 15, wherein the selected activity is a type of product, service, or event that the user enters one or more postings on the one or more social networks and said processing element configured to send an offer to the user based on the type of product, service, or event that the user entered a posting.

20. The apparatus of claim 15, wherein the selected activity is a number or type of product, service or event that the user has selected on the one or more social networks and said processing element configured to send an offer to the user based on either the number or type or products, services, or events the user selects via the one or more social networks.

21. The apparatus of claim 15, wherein the selected activity is one or more selected users affiliated with one or more social networks that are associated with the user and said processing element configured to send an offer to the user based on the fact that the user is associated with the one or more selected affiliated users.

22. The apparatus of claim 15 wherein said processing element is further configured to analyze financial transaction data associated with the user.

23. The apparatus of claim 22, wherein said processing element is further configured to send an offer to the user based at least in part on the selected activity of the user and the financial data associated with the user.

24. The apparatus of claim 15 wherein said processing element is further configured to:
analyze financial transaction data associated with the user and associated with other users affiliated with a social network that are also associated with the user;
determine based at least in part on the financial data whether a selected activity of the user influences the other users to perform the same activity; and
send an offer to the user based on determining that the user influences other users.

25. The apparatus of claim 24 wherein said processing element determines that other users purchase a product or service or select an event after user has purchased the product or service or selected the event.

26. The apparatus of claim 15 wherein said processing element is configured to:
analyze financial transaction data associated with the user and associated with other users affiliated with a social network that are also associated with the user;
determine based at least in part on the financial data whether a selected activity of one or more of the other users influences the user to perform the same activity; and
send an offer to the user based on determining that the user is influenced by one or more of the other users.

27. The apparatus of claim 15 wherein said processing element is configured to:
analyze financial transaction data associated with the user and associated with other users affiliated with a social network that are also associated with the user;
determine based at least in part on the financial data whether one or more of the other users engage in a selected financial behavior; and
send an offer regarding a credit decision to the user based at least in part on the user's association with other users in the social network that engage in the selected financial behavior.

28. The apparatus of claim 27 wherein said processing element is configured to:
compare financial transaction data associated with other users with the financial transaction data associated with the user;
determine that at least one of the other users exerts an influence on a financial behavior of the user; and
modify the credit decision based at least in part on the extent of the influence.

29. A computer program product comprising a non-transitory computer-readable medium, wherein the non-transitory computer-readable medium comprises computer-executable program code stored therein, wherein the computer-executable program code portions comprise:
a first program code portion configured to receive data from one or more social media networks associated with a user;
a second program code portion configured to determine a selected activity of the user associated with the one or more social media networks based on the data using a processor; and
a third program code portion configured to send an offer to the user based at least in part on the selected activity of the user.

30. The computer program product of claim 29, wherein the selected activity is the number of affiliated users with a social network that are associated with the user and said third program code portion is configured to send an offer to the user if the number of affiliated users associated with the user is greater than or equal to a selected value.

31. The computer program product of claim 29, wherein the selected activity is number of times the user enters postings on the one or more social networks and said third program code portion is configured to send an offer to the user if the number of posts made by the user is greater than or equal to a selected value.

32. The computer program product of claim 29, wherein the selected activity is the number of times that affiliated users to a social network respond to one or more posts entered by the user on the social network and said third program code portion is configured to send an offer to the user if the number of times that affiliated users respond to one or more posts by a user is greater than or equal to a selected value.

33. The computer program product of claim 29, wherein the selected activity is a type of product, service, or event that the user enters one or more postings on the one or more social networks and said third program code portion is configured to send an offer to the user based on the type of product, service, or event that the user entered a posting.

34. The computer program product of claim 29, wherein the selected activity is a number or type of product, service or event that the user has selected on the one or more social networks and said third program code portion is configured to send an offer to the user based on either the number or type or products, services, or events the user selects via the one or more social networks.

35. The computer program product of claim 29, wherein the selected activity is one or more selected users affiliated with one or more social networks that are associated with the user and said sending an offer comprises sending an offer to the user based on the fact that the user is associated with the one or more selected affiliated users.

36. The computer program product of claim 29 further comprising a fourth program code portion configured to analyze financial transaction data associated with the user.

37. The computer program product of claim 36, wherein said third program code portion is configured to send an offer to the user based at least in part on the selected activity of the user and the financial data associated with the user.

38. The computer program product of claim 29 further comprising:
fourth program code portion configured to analyze financial transaction data associated with the user and associated with other users affiliated with a social network that are also associated with the user;
fifth program code portion configured to determine based at least in part on the financial data whether a selected activity of the user influences the other users to perform the same activity,
wherein said third program code portion is configured to send an offer to the user based on determining that the user influences other users.

39. The computer program product of claim 38, wherein said fifth program code portion is configured to determine that other users purchase a product or service or select an event after user has purchased the product or service or selected the event.

40. The computer program product of claim 29 further comprising:
fourth program code portion configured to analyze financial transaction data associated with the user and associated with other users affiliated with a social network that are also associated with the user;
fifth program code portion configured to determine based at least in part on the financial data whether a selected activity of one or more of the other users influences the user to perform the same activity,
wherein said third program code portion is configured to send an offer to the user based on determining that the user is influenced by one or more of the other users.

41. The computer program product of claim 29 further comprising:
fourth program code portion configured to analyze financial transaction data associated with the user and associated with other users affiliated with a social network that are also associated with the user;
fifth program code portion configured to determine based at least in part on the financial data whether one or more of the other users engage in a selected financial behavior;
wherein said third program code portion is configured to send an offer regarding a credit decision to the user based at least in part on the user's association with other users in the social network that engage in the selected financial behavior.

42. The computer program product of claim 41 further comprising:
sixth program code portion configured to compare financial transaction data associated with other users with the financial transaction data associated with the user;
seventh program code portion configured to determine that at least one of the other users exerts an influence on a financial behavior of the user; and
eighth program code portion configured to modify the credit decision based at least in part on the extent of the influence.
